(19) United States
(12) Patent Application Publication
(10) Pub. No.: US 2018/0257908 A1
(43) Pub. Date: Sep. 13, 2018

(54) ELEVATOR ARRANGEMENT ADAPTED FOR DETERMINING POSITIONS OF FIXTURES AT VARIOUS FLOORS BASED ON SOUND MEASUREMENTS

(71) Applicant: Inventio AG, Hergiswil (CH)

(72) Inventor: Christoph Moeller, Hergiswil (CH)

(21) Appl. No.: 15/763,225

(22) PCT Filed: Sep. 23, 2016
(86) PCT No.: PCT/EP2016/072635

§ 371 Date: Mar. 26, 2018

(30) Foreign Application Priority Data
Sep. 28, 2015 (EP) 15187111.8

(51) Int. Cl. B66B 1/34; B66B 19/00

(52) U.S. Cl. CPC B66B 1/3407; B66B 19/00; B66B 1/3492; B66B 1/3446

(57) ABSTRACT

An elevator arrangement has a car displaceable within an elevator shaft between building floors, an elevator control and a fixture located at each floors and connected to the elevator control for an exchange of information. Each fixture includes a sound detector detecting sound propagating within the shaft. The arrangement performs a fixture position learning procedure by determining position information for each fixture based on sound characteristics detected by the sound detector and storing the determined position information for subsequent identification of each of the fixtures. Changes in sound characteristics are detected while the car is displaced through the shaft. Time-dependent occurrences of sound pressure peaks or frequency shifts due to Doppler effects are measured at the fixtures and fixture position information is derived from a sequence order of such occurrences or, alternatively, by correlating the occurrence of sound characteristic changes with current car position information provided by the elevator control.

### FIELD

The present invention relates to an elevator arrangement. Particularly, the present invention relates to determining positions of various fixtures of the elevator arrangement. Furthermore, the invention relates to a method for determining such position information, to a computer program product enabling automated performing of such method and to a computer-readable medium comprising such computer program product stored thereon.

### BACKGROUND

Elevators are typically used for transporting persons or items between various levels, i.e. for vertically transporting people or items in an elevator car for example between floors within a building.

Generally, at each of the floors, fixtures are provided. Such fixtures may serve various purposes. For example, a fixture may be provided in a form of a landing operation panel (LOP) and may be used by users in order to call a car of the elevator to come to a specific floor. Such landing operation panels typically comprise one or more call buttons or other means for determining a user's request. Other fixtures may serve e.g. for providing information to a user. For example, such fixtures may comprise a display, lights, indicators, loudspeakers etc. and may indicate information for example about a current position of the elevator car and/or its moving direction. Other fixtures may be provided within the floors of the building for further purposes.

Typically, in order to be able to properly operate, an elevator arrangement must have information about the positions of each of its fixtures.

For example, in order to correctly control a motion of the elevator car, an elevator control must know the position of the LOP at which a user has requested an elevator car e.g. by pushing the call button. Only when the position of such fixture is known to the elevator control, the elevator control may control driving the car to the floor where the user is waiting.

Generally, it is beneficial to provide all fixtures serving for a same or similar purpose within a building with an identical hardware. Accordingly, when installing the elevator arrangement, each fixture may be mounted at any of the various floors within the building. This may save costs and simplify logistics.

However, after installation, as the elevator control can initially not distinguish between the various fixtures located at the various floors, it is generally necessary to identify the position of each of the fixtures of the elevator arrangement such that, during subsequent normal operation of the elevator control, such information may be used by the elevator control e.g. for correctly controlling for example a car motion.

Conventionally, identifying the position of a fixture has been carried out for example by means of several switches being included into each of the fixtures wherein the switching state of the switches provided for a unique identification pattern upon which the elevator control could distinguish between the various fixtures. In such conventional approach, installation personnel had to manually set in each instance and at every floor the several switches of each of the fixtures. Configurations manually carried out in such manner required a high outlay in terms of time and personnel. Furthermore, the switches represented costly components.

An alternative approach is described in U.S. Pat. No. 7,699,143 B2 disclosing a method of setting the floor associations of a plurality of operating units of an elevator installation.

There may be a need for an elevator arrangement which enables determining of position information of fixtures located at various floors in a simple manner. Particularly, there may be a need for such elevator arrangement in which position information determination may be provided with minimum human labor, i.e. preferably semi-automatically or fully automatically. Furthermore, there may be a need for an elevator arrangement in which such position information determination may be provided at relatively low cost and/or at short time. Furthermore, there may be a need for a corresponding method for determining position information, a computer program product enabling such method when executed on a programmable elevator control and a computer-readable medium comprising such computer program product.

### SUMMARY

According to a first aspect of the present invention, an elevator arrangement comprising a car, an elevator control and a plurality of fixtures is proposed. The car is displaceable within an elevator shaft between various floors within a building. The elevator control may control functions of the elevator arrangement such as displacements of the car. Each of the fixtures is located at one of the floors and is connected to the elevator control for an exchange of information. Specifically, each fixture comprises a sound detector which is specifically arranged and adapted for predominantly detecting sound characteristics of sound propagating within the elevator shaft.

Therein, according to a preferred embodiment, the elevator arrangement is adapted to perform a fixture position learning procedure comprising at least the following steps: First, a position information is determined for each of the fixtures located at each of the floors based on sound characteristics of sound propagating within the elevator shaft, the sound being detected by the sound detector comprised in the fixture located at the respective floor. Then, this determined position information is stored for subsequent identification purposes for each of the fixture.

Without restricting the scope of the inventions, ideas underlying embodiments of the present invention may be interpreted as being based, inter alia, on the following observations and recognitions.

As indicated in the introduction above, it may be beneficial to enable an elevator arrangement to semi-automatically or fully-automatically learn the positions of each of its fixtures, i.e. to enable the elevator arrangement to uniquely identify each of its fixtures and having information for example about the floor at which the fixture is arranged.

In order to enable such fixture position learning procedure, it is suggested to include a sound detector into each of the fixtures of the elevator arrangement. Such sound detector may measure sound characteristics such as sound pressures, sound frequencies, sound patterns, etc. in the sound detector's environment. Herein, “sound” may be interpreted in a broad sense as being any periodic air pressure variation in a frequency range of e.g. 1 Hz to 100 kHz, preferably in an acoustic audible spectrum of between 20 Hz and 10 kHz. Furthermore, “sound” may be any tone or noise, including e.g. single frequencies air pressure waves or a superposition of multiple frequencies.

As proposed herein, the capability of detecting and analyzing sound characteristics of sound in an environment of the elevator arrangement, particularly in an environment within an elevator shaft adjacent to a fixture, may enable using results of such sound measurements in order to derive information about positions of plural fixtures within the elevator arrangement. Details on possibilities for enabling using measured sound characteristics for discriminating between various locations of fixtures will be given further below with respect to several specific embodiments.

Particularly, the sound detector shall be specifically configured and arranged such that it may predominantly detect sound characteristics of sound propagating within the elevator shaft. In other words, the sound detector may be specifically configured and arranged such that sound propagating in the elevator shaft influences a sound detection result significantly more than sound propagating in another environment of the sound detector. Accordingly, the sound detector “listens” more to what is happening within the elevator shaft than to what is happening e.g. on a floor outside the elevator shaft.

For example, according to an embodiment, the sound detectors each are provided with a sound transmitting connection to the elevator shaft, the sound detectors and the sound transmitting connection being arranged and adapted such that sound propagating within the elevator shaft is transmitted to the sound detector with a significantly lower acoustic damping than sound from outside the elevator shaft.

In other words, there may be a sound transmitting connection which is adapted such that sound generated and/or propagating within the elevator shaft can reach the sound detector without being significantly damped whereas sound generated outside the elevator shaft is hindered to reach the sound detector for example due to effective sound damping measures.

For example, the sound detector may be arranged within the fixture such that a sound sensing surface of the detector is in direct fluid connection, i.e. in connection e.g. via a hole or a pipe through a wall, with an interior volume in the elevator shaft. In many cases, such direct fluid connection can be easily established as the fixture comprises e.g. wirings which extend through a hole in a wall of the elevator shaft into an interior volume of the elevator shaft. Accordingly, any sound, i.e. any periodic pressure change, within air comprised in the elevator shaft is directly transmitted to and measurable by the sound detector.

Alternatively, the sound detector may be at least in indirect contact with an interior air volume within the elevator shaft such that pressure variations created by sound are at least indirectly transmitted to and measurable by the sound detector. For example, the sound detector may be encapsulated within the fixture using e.g. a thin membrane. Such membrane may prevent any fluid flow to the sound detector such that e.g. the sound detector is protected against for example water or dirt but may allow that pressure variations, i.e. sound, are transmitted to the sound sensing surface of the sound detector.

For example, the sound detector may be a microphone, i.e. an acoustic-to-electric transducer or sensor that converts sound into an electrical signal. The sound detector may be installed in or at the fixture, particularly e.g. in a housing of the fixture. The fixture may be installed next to the elevator shaft in a way such that a passenger on a floor may access the fixture e.g. for calling an elevator car. Particularly, a housing of the fixture may be exposed to the floor and/or may be accessible from the floor.

However, a sound detector comprised within or at the fixture shall not mainly detect sound generated in the floor but, to the contrary, shall mainly detect sound generated in the elevator shaft. For such purpose, the sound transmitting connection between the sound detector and the elevator shaft may be provided. Such sound transmitting connection may be e.g. a simple hole in the housing of the fixture and/or in a wall separating the fixture from the elevator shaft. Such hole may comprise a suitable cross section for sufficient sound transmission, e.g. more than 0.5 cm² or more than 2 cm². Alternatively, e.g. a pipe or a solid bar may acoustically connect the sound detector with the elevator shaft. The pipe or bar may be made e.g. from metal which may have good acoustic transmission characteristics. The hole, pipe or bar may be arranged such that sound propagating within the elevator shaft may easily be transmitted through e.g. the wall of the elevator shaft towards the fixture and particularly towards the sound detector comprised therein. On the other hand, sound damping provisions may be made at other portions of the fixture such that sound which is not coming from the elevator shaft is substantially damped and may therefore not negatively interfere with the sound characteristics from the elevator shaft to be measured.

For example, the sound transmission connection, on the one hand, and any sound damping measures, on the other hand, may be provided such that sound from the elevator shaft is damped by at least 5 dB, preferably at least 10 dB or at least 15 dB, less than sound not coming from the elevator shaft.

According to an embodiment, the elevator arrangement is adapted such that, in the fixture position learning procedure, each or at least some of the sound detectors transmit information on a change in sound characteristics over time to the elevator control and the elevator control determines the position information for each of the respective fixtures based on the transmitted information on the changes in sound characteristics over time.

In other words, the sound detectors may continuously or repeatedly monitor a sound such as an operational sound inherently created upon operating the elevator arrangement and/or an artificial sound created using an artificial sound generator e.g. within the elevator shaft. Upon such monitoring, the sound detectors may detect changes in sound characteristics over time and may transmit corresponding information to the elevator control. Upon receiving such corresponding information from each of the fixtures, the elevator control may determine the position information for each of the fixtures.

For example, the information on a change in sound characteristics over time may comprise information about a change in sound pressure, information about a change in a sound frequency spectrum and/or information about a point in time at which the change in sound characteristics is detected.

In other words, the sound detector may be adapted to measure variations in sound pressure within the elevator shaft, such sound pressure corresponding to a sound volume or loudness of sound propagating in the elevator shaft. The sound pressure detected at a specific sound detector may vary e.g. due to a sound source changing its emitted sound and/or due to the sound source changing its position relative to the sound detector. Such changes in sound pressure may be detected with a detection sensitivity of the sound pressure level being e.g. less than 5 dB, preferably less than 1 dB.

Alternatively or additionally, the sound detector may be adapted to measure variations in a frequency spectrum of sound within the elevator shaft. The sound frequency spectrum describes the frequencies of sound propagating in the elevator shaft. For example, the sound frequency spectrum may include a base frequency component and typically several higher harmonic components. Alternatively, the sound frequency spectrum of e.g. noise may comprise a superposition of many independent frequencies. The sound frequency spectrum detected at a specific sound detector may vary e.g. due to a sound source changing its emitted sound spectrum and/or due to the sound source changing its velocity relative to the sound detector, thereby resulting in different Doppler shifts for the detected sound spectrum. Such changes in the sound frequency spectrum may be detected with a detection sensitivity of the frequencies being e.g. less than 100 Hz, preferably less than 20 Hz, less than 5 Hz or even less than 1 Hz.

Furthermore, alternatively or additionally, the sound detector may be adapted to measure a point in time at which a specific change in sound characteristics within the elevator shaft is detected. Such change in sound characteristics may result e.g. from the sound being generated with a specific time sound pattern. For example, the sound may be generated with a pattern of temporally increasing and decreasing loudness. Or the sound may be emitted with a pattern of temporally increasing and decreasing frequency. Such sound pattern characteristics may be changed e.g. by controlling a sound source e.g. within a time frame of less than 20 s, preferably less than 2 s, but preferably more than 20 ms. Alternatively, the change in sound characteristics may result from the sound source being moved within the elevator shaft such that a specific sound detector detects an increasing sound pressure when the sound source approaches the sound detector and detects a fading sound pressure when the sound source departs. Such relatively slow changes of sound characteristics and the detection of the point in time at which they occur may be resolved e.g. with an accuracy of less than 30 s, preferably less than 5 s, but preferably more than 0.2 s.

For example, according to an embodiment, the elevator arrangement may be adapted such that, in the fixture position learning procedure, the car is driven to each of the floors. Therein, the car may or may not stop at the floors.

Typically, when an elevator car is driven through an elevator shaft, it generates sound, i.e. noise, within the elevator shaft. Such sound may be inherently generated e.g. due to rollers sliding along guide profiles, due to air turbulences, due to a machine driving the car, etc. For example, when the car approaches towards a specific location in the elevator shaft, local sound characteristics, i.e. particularly local sound pressure, at this location may temporarily increase whereas when the car moves away from the location, local sound pressure at this location may generally decrease. Additionally, due to Doppler effects, a frequency spectrum of sound generated by a sound generator approaching a sound detector comprises higher frequencies than a frequency spectrum of sound generated by a sound generator moving away from a sound detector. Accordingly, when the car passes along the location of the sound detector, there will typically be a detectable change in sound characteristics, particularly in sound pressures and sound frequencies. Such temporary change in sound characteristics may be detected by the sound detector of the fixtures and, upon receiving corresponding signals from the fixtures, the elevator control may derive the position information for each of the fixtures.

Particularly, it may be beneficial that, in the fixture position learning procedure, the car and/or counterweight may be travelled continuously through several or all of the floors within a building without necessarily stopping at each of the floors. For example, the car and/or counterweight may be driven continuously from one end of the elevator shaft to the opposite end without interruptions or stops. Thereby, the fixture position learning procedure may be performed in very short time and, preferably, no or little human interaction is necessary.

For example, when detecting the change in sound characteristics over time and, additionally, having e.g. an information about the current location of the car within the elevator shaft, such information being available for example from the elevator control, an information about the location of the fixture measuring the change in sound characteristics over time with its sound detector may be derived. Thus, in the fixture position learning procedure, the position information may be obtained for each of the fixtures by e.g. simply traveling the car through the entire elevator shaft and correlating information about each of multiple changes in sound characteristics over time measured by the various sound detectors with information about the current position of the car.

According to a specific embodiment, a moving component being mechanically connected to the elevator car comprises a sound generator which is adapted for generating a specific sound during a fixture position learning procedure.

Such sound generator may be e.g. a loud speaker, a diaphone, a hooter, etc. The sound generator may be controlled to generate one or various specific types of sounds. The sound generator may be attached to any component connected to and displaceable together with the elevator car. Therefore, such sound generator will be referred to herein as “displaceable sound generator”. For example, the sound generator may be attached to the car itself. Alternatively, the sound generator may be attached e.g. to a counterweight or to a suspension member connected to the car. The sound generator may generate a specific sound having specific sound characteristics. Such characteristics may include, inter alia, a sound frequency spectrum, a sound time pattern, etc. When performing a fixture position learning procedure, the sound generator may be moved through the elevator shaft. Upon such movement, the sound generator may generate a specific sound continuously or at specific time intervals.

According to an embodiment, alternatively or additional to a displaceable sound generator, the elevator arrangement may further comprise a fixed sound generator being fixedly installed within the elevator shaft, such fixed sound generator being adapted for generating a specific sound during a fixture position learning procedure.

Such fixed sound generator may be implemented with similar features as described above with respect to the displaceable sound generator. However, contrary to the displaceable sound generator, it may not be moved within the elevator shaft but is fixedly installed therein. For example, such sound generator may be installed at a fixed position within the elevator shaft such as at its upper end or its lower end.

The fixed sound generator may generate a specific sound similarly to the specific sound described above for the displaceable sound generator. The sound detectors of the various fixtures may detect such generated sound. As each of the fixtures is positioned at another one of the floors and, thus, within a different distance to the fixed sound generator, the specific sound generated at the fixed sound generator reaches the various sound detectors at different points in time and/or with different sound characteristics. Accordingly, position information for each of the fixtures may be derived from the signals provided by each of the sound detectors.

According to an embodiment, in determining the position information, the elevator control takes into account a time sequence with which an information on a similar change in sound characteristics over time is received by the elevator control from each of the fixtures.

Such embodiment may be implemented in different ways.

In a first implementation, sound is generated by a displaceable sound source such as a moving elevator car itself or a displaceable sound generator. During the fixture position learning procedure, the car and/or the sound generator is moved throughout the elevator shaft, for example from one end to an opposite end. Each time the car and/or the sound generator comes close to one of the fixtures, the sound detector of this fixture will detect a temporary increase in sound pressure and/or a change in detected sound frequencies due to the elevator car and/or the sound generator passing by. As the car and/or the sound generator move sequentially from floor to floor, the sound detectors in the fixtures at these floors will detect similar changes in sound characteristics. Accordingly, the elevator control will receive similar signals from each of the sound detectors with a specific time delay between signals from sound detectors at vertically neighboring floors. From a sequence with which the similar signals are received, the elevator may derive information about a sequential order with which the fixtures are arranged along the path though the elevator shaft. Accordingly, the time sequence of the similar sound signals received at the elevator control may be used to provide the desired position information.

In a second implementation, sound may be generated using a fixedly installed sound generator. For example, the sound generator may be installed at one end of the elevator shaft. The sound generator may emit sound with a specific time-dependent sound pattern, i.e. for example as a pulse or a pulse-like signal, such as e.g. with single or plural short-term beeps. The sound moves through the elevator shaft with the speed of sound, i.e. with approximately 300 m/s. Accordingly, the sound pattern will arrive at the different fixtures provided at the various floors at different points in time. Thus, using acoustical logging, the position information of the fixtures may be derived from the order with which the emitted sound pattern is detected by the sound detectors of the various fixtures. In such implementation, the fixture position learning procedure may be performed particularly fast as e.g. no movements of the elevator car are necessary.

In both implementations, sound indicating signals may be forwarded from the sound detectors to the elevator control, which in turn may determine from the transmitted signals whether there are included information on a similar change in sound characteristics over time, i.e. whether there are typical changes in sound characteristics as occurs when e.g. the elevator car passes by at one the sound detectors or whether there are changes in sound characteristics corresponding to detecting a specific sound pattern emitted by a fixed sound generator. Accordingly, the elevator control may be “intelligent”, i.e. may be able to process sound signals from the sound detectors whereas the sound detectors in the fixtures may only relay its sound information to the elevator control. For example, the elevator arrangement may be enabled to process sound signals or information only in a “learning mode”, i.e. during the fixture position learning procedure.

According to an embodiment, the elevator arrangement is adapted to executing the fixture position learning procedure automatically, i.e. semi-automatically or fully automatically, under control of the elevator control.

In other words, the fixture position learning procedure may be performed by the elevator arrangement without necessarily any human interaction, i.e. fully automatically, or with only limited human interaction, i.e. semi-automatically. Accordingly, when the elevator arrangement is installed within a building, the fixture position learning procedure may be initiated and may then automatically determine position information for all of the fixtures included in the elevator arrangement.

Particularly, in accordance with an embodiment, in the fixture position learning procedure, the elevator control may identify an identity of each of the fixtures based on a unique identification code being transmitted from the fixture together with the transmitted information on the detected sound. Alternatively, the elevator control may identify the identity of each of the fixtures based on a hard-wiring connection between each one of the fixtures and the elevator control.

In other words, when a sound detector in a fixture has measured a sound characteristic, the fixture may not only transmit the measurement result to the elevator control but may also transmit an identification code (ID) which may uniquely identify the respective fixture. Based on the various sound measurement results received from the various fixtures, the elevator control may then derive the position information for each of the fixtures based on e.g. the order of measured changes in the detected sound characteristics. The position information may then be stored together with the identification codes for subsequent identification purposes for each of the fixtures. In other words, e.g. a list may be stored in which each identification code is attributed to an associated one of the floors of the building.

Alternatively, instead of using unique identification codes for identifying each fixture, the identity of each fixture may be determined based on its hard-wiring to the elevator control. In other words, when each of the fixtures is hard-wired to the elevator control, upon receiving the information on the various sound characteristics measured by the sound detectors, the elevator control may create a list storing the information about an order of the measured changes in sound characteristics together with the information about the hard-wiring via which these measured signals is transmitted, i.e. about which sound detector has provided this measurement result in its fixture.

Preferably, in a normal operation mode, the elevator control is adapted to identify each of the fixtures based on the information stored for subsequent identification purposes during the fixture position learning procedure. In other words, the position information or further information derived therefrom may be used by the elevator control during a subsequent normal operation mode in order to uniquely identify the position of each of the fixtures of the elevator arrangement to thereby enable for example proper operation of the elevator arrangement.

According to a second aspect of the invention, a method for determining position information for each of a plurality of fixtures of an elevator arrangement is proposed. Therein, the fixtures are located at various floors within a building and each fixture comprises a sound detector which is arranged and adapted for predominantly detecting sound characteristics of sound propagating within the elevator shaft. The method comprises determining a position information for each of the fixtures located at each of the floors based on sound characteristics of sound propagating within the elevator shaft detected by the sound detector comprised in the fixture located at the respective floor and storing the determined position information for subsequent identification purposes for each of the fixtures.

Such position information determination method may be specifically applied for use with an elevator arrangement according to an embodiment of the present invention. Particularly, the method may be performed semi-automatically or fully automatically. Therein, each of the method steps may be controlled for example by the elevator control of an elevator arrangement.

According to a third aspect, a computer program product is described. Such computer program product comprises computer-readable instructions which are adapted for, when executed by a processor of e.g. a programmable elevator control, controlling the method according to the above described second aspect of the invention.

Such computer program product may comprise computer-readable instructions in any programming language. The instructions may instruct the programmable elevator control to control e.g. travelling of the car, reading sound detection measurements and determining of position information by e.g. correlating information derived from read sound detection measurements for example with information on a current position of the car.

According to a fourth aspect of the present invention, a computer-readable medium comprising a computer program product according to the above-mentioned third aspect of the invention stored thereon is suggested. Such computer-readable medium may be any physical memory which allows storing computer-readable instructions and/or which enables downloading of such computer-readable instructions. For example, the computer-readable medium may be a CD, a DVD, flash memory, EPROM, parts of the internet providing download options or similar.

It shall be noted that possible features and advantages of embodiments of the invention are described herein partly with respect to an elevator arrangement and partly with respect to a method for determining position information for each of a plurality of fixtures of an elevator arrangement. One skilled person will recognize that features described for one embodiment may be suitably transferred, adapted, or modified for application with other embodiments and/or may be combined and/or replaced with other features described for other embodiments in order to come to further embodiments of the invention.

In the following, advantageous embodiments of the invention will be described with reference to the enclosed drawings. However, neither the drawings nor the description shall be interpreted as limiting the invention.

### DESCRIPTION OF THE DRAWINGS

FIG. 1 shows a cross-sectional view through an elevator arrangement according to an embodiment of the present invention.

FIG. 2 is a schematic representation of two functional principles of an elevator arrangement according to an embodiment of the present invention.

FIG. 3 is a schematic representation of a functional principle of an elevator arrangement according to an alternative embodiment of the present invention.

The figures are only schematic representations and not to scale. Same reference signs refer to same or similar features.

### DETAILED DESCRIPTION

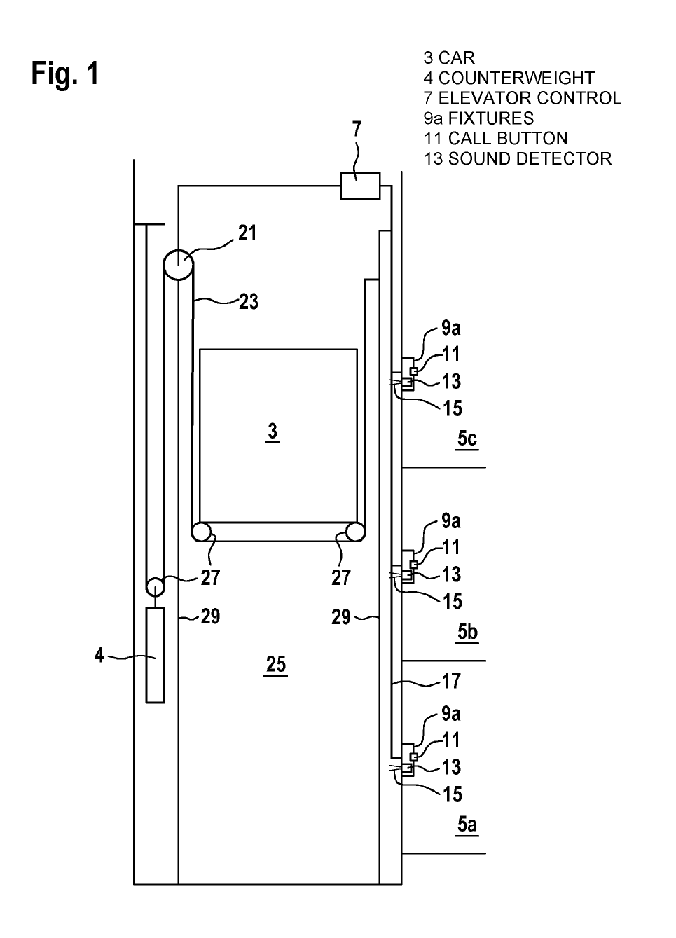

FIG. 1 shows an elevator arrangement 1 according to an embodiment of the present invention. The elevator arrangement 1 comprises a car 3 and a counterweight 4 which are held by suspension members 23 such as ropes or belts. The suspension members 23 are wound around pulleys 27. The car 3 and the counterweight 4 may be vertically displaced within an elevator shaft 25 to different levels corresponding to various floors 5a, 5b, 5c within a building using a driving machine 21 driving the suspension members 23. An elevator control 7 may control displacements of the car 3 between the various floors 5a, 5b, 5c. During such displacements, the car 3 and/or the counterweight 4 are guided by guide rails 29 mounted along walls of the elevator shaft 25.

At each of the floors 5a, 5b, 5c, a respective fixture 9a, 9b, 9c is provided. In the example presented in the figure, the fixtures 9a, 9b, 9c are landing operation panels (LOP) and comprise a call button 11 which a user may press e.g. in order to announce his request to drive the car 3 to the floor where he is currently waiting.

However, in other examples, a fixture may be any other device which may be provided at the floors for acquiring or providing any information or services from and/or to users, such as e.g. acquiring requests from a user via any type of human machine interface (HMI) or providing information to a user e.g. via a display, a loudspeaker, etc.

Preferably, all fixtures 9a, 9b, 9c at all floors 5a, 5b, 5c may be provided with the same hardware. The fixtures 9a, 9b, 9c may be connected to the elevator control 7 for example via a hard-wiring 17. Such hard-wiring 17 typically extends along walls at an interior of the elevator shaft 25. Alternatively, the fixtures 9a, 9b, 9c may communicate with the elevator control 7 via a wireless connection, e.g. using a unique fixture ID.

Furthermore, each of the fixtures 9a, 9b, 9c comprises a sound detector 13. This sound detector 13 is arranged and adapted such that it mainly detects sound within the elevator shaft 25 whereas sound from other environments of the sound detector 13 shall be significantly damped.

In the example shown, each sound detector 13 is in fluid communication with the interior volume of the elevator shaft 25 via a sound transmitting connection 15 which, in the present example, is formed by a pipe extending through a wall of the elevator shaft 25. Any other type of sound transmitting connection 15 such as a hole, a tube, a solid or hollow bar, etc. may be possible, wherein the sound transmitting connection 15 may be open such that a gas exchange is possible or may be closed e.g. via a membrane such that only pressure changes forming sound may be transmitted but no gas exchange is possible. Via such sound transmitting connection 15 the sound detector 13 may detect sound propagating within the elevator shaft 25.

By measuring sound characteristics in its environment, the sound detector 13 may help in determining a position information of its fixture 9a, 9b or 9c, such position information indicating at which floor 5a, 5b or 5c the fixture 9a, 9b or 9c is located. Based on such position information, the elevator control 7 may later know for example at which floor 5a, 5b or 5c the fixture 9a, 9b or 9c is positioned from which a request or an information has been transmitted to the elevator control 7 and may e.g. send the car 3 to this floor 5a, 5b, 5c.

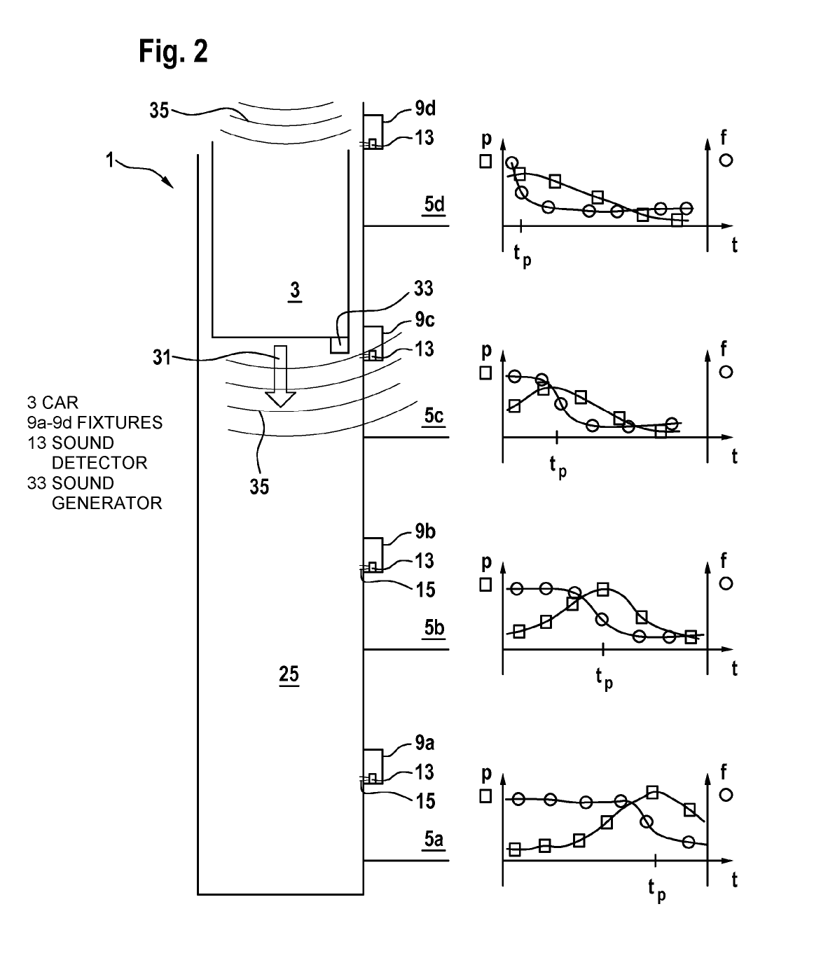

FIG. 2 visualizes two possible functional principles to be applied in an elevator arrangement according to an embodiment of the present invention.

According to a first embodiment, in a fixture position learning procedure, the elevator car 3 is driven in a motion direction 31 through the elevator shaft 25 along each of the floors 5a, 5b, 5c, 5d, etc. For example, the elevator car 3 may start its journey at an upper most floor and may then travel to a lowest floor 5a.

During such motion, the elevator car 3 itself generally generates a certain degree of noise, for example due to rollers rolling along guide rails 29, air turbulences, etc. Such noise is sound which may be detected by each of the sound detectors 13 comprised in each of the fixtures 9a, 9b, 9c, 9d, etc.

Alternatively, a displaceable sound generator 33 such as a loudspeaker, horn, hooter, etc. may be attached to the elevator car 3 and may generate additional sound during the car's journey through the elevator shaft 25. While a noise generated by the elevator car 3 itself may hardly be significantly influenced, a sound generated by such additional sound generator 33 may be emitted with controllable characteristics, such characteristics comprising inter alia a loudness, a sound frequency spectrum, a sound pattern, etc.

Independent on how the sound is generated during the journey of the elevator car 3, two different sound detection principles may be applied in order to determine a position information for each of the fixtures 9a, 9b, 9c, 9d, etc.

In a first approach, a sound pressure level p is measured at each of the fixtures 9a, 9b, 9c, 9d by its associated sound detector 13. Corresponding sound pressure level curves are visualized in FIG. 2 with the “□” symbol. Generally, a detected sound pressure level p is highest when the elevator car 3 is directly passing along a respective sound detector 13 of a fixture 9a, 9b, 9c, 9d whereas the sound pressure level p is lower as long as the elevator car 3 is significantly distant to such sound detector 13. Accordingly, during the journey of the elevator car 3 through the elevator shaft 25, a point in time tp at which a sound detector 13 of one of the fixtures 9a, 9b, 9c, 9d detects a sound pressure level peak will depend on a time sequence with which the elevator car 3 passes along the various fixtures 9a, 9b, 9c, 9d.

As an alternative approach of detecting informative sound characteristics or as an option to provide redundant sound measurement results in order to increase a reliability of measurements, a sound frequency spectrum f may be measured by the sound detectors 13. Such sound frequency spectrum f is visualized by the “◯” symbol in the curves given in FIG. 2. In such sound measurement principle, benefit may be taken from the fact that the sound characteristics detected by a sound detector 13 depend on whether the sound source, i.e. in the given example the car 3 or its displaceable sound generator 33, approaches towards the sound detector 13 or moves away from the sound detector 13.

Specifically, when measuring the sound frequency spectrum f, a mean value of such sound frequency spectrum f will be higher when the elevator car 3 moves towards the sound detector 13 whereas the mean value of the sound frequency spectrum f will be lower when the car 3 moves away from the sound detector 13. Such shift in sound frequency spectrum f results from the Doppler effect and is generally the higher the faster the elevator car 3 travels through the elevator shaft 25. At typical car velocities of e.g. 0.3 m/s to 5 m/s or even more, such sound frequency spectrum shifts may be in a range from several hundred mHz to some Hz and may therefore be easily detectable.

Accordingly, instead or additional to measuring the point in time tp at which a sound pressure level peak occurs, a similar point in time may be determined by measuring when a sound frequency spectrum shift occurs when the elevator car 3 passes by at each of the fixtures 9a, 9b, 9c, 9d.

Accordingly, in the fixture position learning procedure, each sound detector 13 may transmit information on a change in sound characteristics over time, i.e. information on the occurrence of a sound pressure level peak and/or the occurrence of a sound frequency spectrum shift, to the elevator control 7. The elevator control 7 may then determine the position information for each of the fixtures 9a, 9b, 9c, 9d based on such transmitted information on the changes in sound characteristics over time.

Therein, the elevator control may take into account an information on a current position of the elevator car 3, such current position information being typically available in the elevator control in order to be able to control correct displacement of the elevator car within the shaft 25. In other words, when for example a sound detector 13 of a fixture 9c detects a sound pressure level peak or a sound frequency spectrum shift, it may transmit such information to the elevator control 7. Based upon such information, and knowing where the elevator car 3 is currently positioned, the elevator control 7 then knows where the fixture 13 is positioned. Such information may then be stored within the elevator control 7 or may be transmitted to the fixture 13 and be stored there for later use during normal operation of the elevator.

Alternatively, the elevator car 3 may be driven from one end of the elevator shaft 25 to the opposite end thereof. Based on a time sequence at which the changes in sound characteristics, i.e. the sound pressure level peak or the sound frequency spectrum shift, occur, the elevator control 7 may determine the order at which the various fixtures 9a, 9b, 9c, 9d are arranged along the elevator shaft 25 in order to finally determine the position information for each of the fixtures.

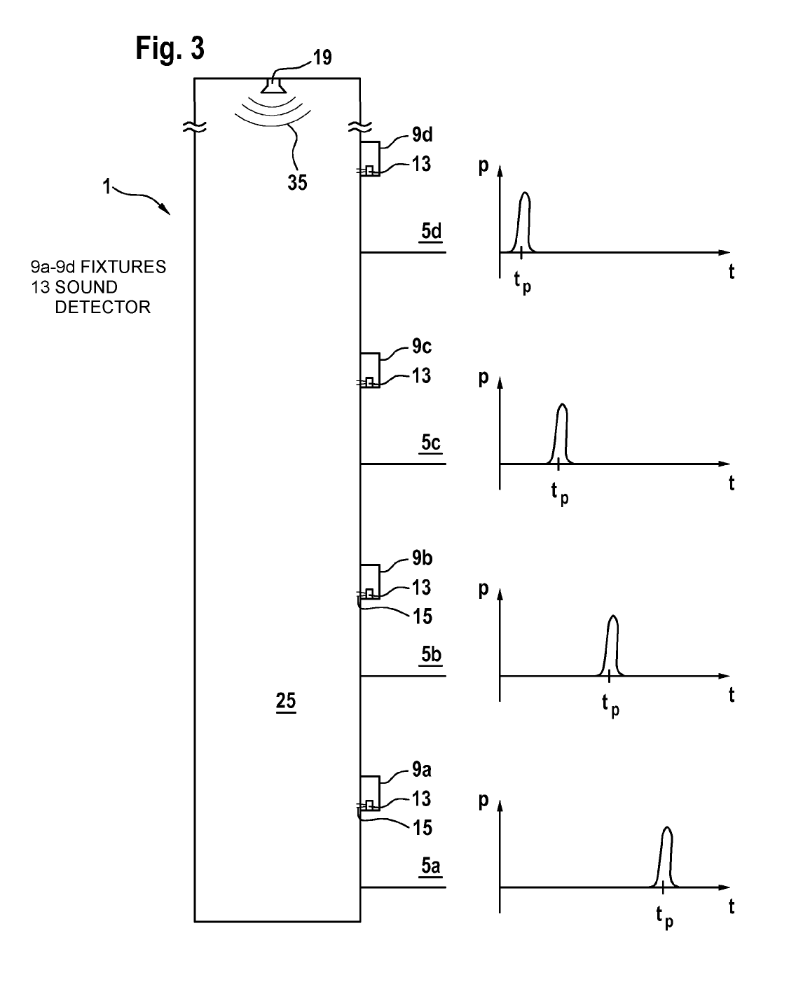

In another embodiment as visualized in FIG. 3 implementing a sound logging procedure, a fixed sound generator 19 is fixedly installed within the elevator shaft 25. Such fixed sound generator 19 is adapted for generating a specific sound 35 such as for example a short beep to be used during a fixture position learning procedure. Such sound 35 propagates through the elevator shaft 25 with the speed of sound of approximately 340 m/s. Accordingly each of the sound detectors 13 comprised in the fixtures 9a, 9b, 9c, 9d will detect the specific sound at a different point in time tp, depending on how far away the sound detector 13 is from the fixed sound generator 19. Accordingly, from a sequence of points in time tp at which the specific sound signal of the sound generator 19 is detected at the various fixtures 9a, 9b, 9c, 9d, the elevator control may derive the position information for each of the fixtures 9a, 9b, 9c, 9d.

It shall be noted that features and principles of the above described embodiments of the invention may be slightly modified without leaving the scope of the invention. For example, in the embodiment explained with reference to FIG. 2, any other moving component of the elevator arrangement 1 may be used as the displaceable sound generator.

For example, instead of the elevator car 3 or an artificial displaceable sound generator 33 attached thereto forming the sound source, for example the counterweight itself or an artificial sound generator attached to the counterweight or to a suspension means may serve as a sound source during the fixture position learning procedure.

Furthermore, instead of using a separate fixed sound generator 19 as explained with reference to FIG. 3, an artificial sound generator 33 attached to for example the elevator car 3 may be used in the sound logging procedure as explained with reference to FIG. 3 wherein the elevator car 3 then remains at a fixed location within the elevator shaft 25 during the fixture position learning procedure.

Briefly summarized and using a different wording, it is proposed to provide each of the fixtures within an elevator arrangement with a sound pressure sensor which may be for example a volume sensor or a microphone. A sound pressure may then be detected by the sound pressure sensor, both in absolute sound pressure or frequency. Measurement info may be provided to the elevator control. Timing info may be available at the elevator control as well. The sound source may simply be the elevator car or any other physical component generating sound or noise, such that no extra costs occur. Alternatively, a dedicated sound pressure emitting element may be provided, for example installed in, on or at the car or the counterweight or, alternatively, at the ceiling or bottom of the elevator shaft.

In a passing car scenario, the elevator performs an installation run. Each fixture sound detector may detect an increase in sound pressure with a subsequent decrease due to a passing of the car. During the peak, it may safely be assumed that the car is nearest to the particular sound detector. Position information of the elevator control may be used to associate a position, i.e. for example a floor, to the respective fixture. Therein, the fixture may be identifiable via its hard-wiring to the elevator control or via a unique identification code.

Instead of a pressure peak, a frequency detection may be used with the Doppler effect identifying a moment of a sound source passing by.

In case no position information is available, a timed sequence of passes/detected sound characteristic changes may be used in order to determine an order of the fixtures, thus establishing an order in arrangement. With additional information, e.g. on a number of floors, the elevator control may then associate a certain floor to a particular fixture.

In another runtime of pressure wave scenario, no movement of the car is necessary. A sound emitting element such as a loudspeaker positioned anywhere at a defined position within the elevator shaft may be used to generate characteristic sound, e.g. a sound pulse, which travels at the speed of sound through the shaft. The sound emitting element may be for example installed at a fixed position at the top of the shaft or the bottom of the shaft or may be attached to a car or counterweight which is then stopped at a defined position, for example at the top or bottom of the elevator shaft, during the fixture position learning procedure. The sound detector may detect a sound pressure peak and using timing information, the elevator control may again determine the position, i.e. for example the floor, of each of the fixtures. From an order of such sound pressure peaks, an order (i.e. a relative position to one another) of the fixtures may be derived. Alternatively, with additional information, an absolute position of the fixtures may be analyzed.

Both, the timing information together with the travelling speed of the car or the timing information of the travelling sound wave with the speed of sound may be used to verify an outcome of such sound measurements.

Finally, it should be noted that terms such as “comprising” do not exclude other elements or steps and the terms “a” or “an” do not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An elevator arrangement comprising:
a car displaceable within an elevator shaft between various floors within a building;
an elevator control controlling displacement of the car;
a plurality of fixtures, each of the fixtures being located at one of the floors and being connected to the elevator control for an exchange of information; and
wherein each of the fixtures includes a sound detector detecting sound characteristics of sound propagating within the elevator shaft and transmitting the detected sound characteristics to the elevator control.

17. The elevator arrangement according to claim 16 wherein the elevator arrangement performs a fixture position learning procedure comprising:
determining a position information for each of the fixtures based on the sound characteristics of the sound propagating within the elevator shaft and detected by the sound detector included in the fixture; and
storing the determined position information for subsequent identification purposes for each of the fixtures.

18. The elevator arrangement according to claim 16 wherein each of the sound detectors is provided with a sound transmitting connection to an interior of the elevator shaft, the sound detectors and the sound transmitting connections being arranged such that the sound propagating within the elevator shaft is transmitted to the sound detectors with a significantly lower acoustic damping than sound from outside the elevator shaft is transmitted to the sound detectors.

19. The elevator arrangement according to claim 16 wherein during a fixture position learning procedure at least some of the sound detectors transmit information on a change in the sound characteristics over time to the elevator control and the elevator control determines the position information for the fixtures associated with the respective some of the sound detectors based on the transmitted information on the changes in sound characteristics over time.

20. The elevator arrangement according to claim 19 wherein the information on the change in the sound characteristics over time includes at least one of information about a change in sound pressure, information about a change in a sound frequency spectrum and information about a point in time at which the change in the sound characteristics is detected.

21. The elevator arrangement according to claim 16 wherein the elevator arrangement, during a fixture position learning procedure, drives the car to each of the floors.

22. The elevator arrangement according to claim 21 wherein a moving component mechanically connected to the car includes a displaceable sound generator generating a specific sound during the fixture position learning procedure.

23. The elevator arrangement according to claim 21 wherein, in determining the position information, the elevator control takes into account an information on a current position of the elevator car.

24. The elevator arrangement according to claim 16 including a fixed sound generator fixedly installed within the elevator shaft, the fixed sound generator generating a specific sound during a fixture position learning procedure performed by the elevator arrangement.

25. The elevator arrangement according to claim 24 wherein in determining the position information, the elevator control takes into account a time sequence with which an information on a similar change in the sound characteristics over time is received by the elevator control from each of the fixtures.

26. The elevator arrangement according to claim 16 wherein the elevator arrangement performs a fixture position learning procedure automatically under control of the elevator control.

27. The elevator arrangement according to claim 16 wherein, during a fixture position learning procedure, the elevator control identifies an identity of each of the fixtures based on at least one of a unique identification code being transmitted from each one of the fixtures together with the transmitted information on the detected sound characteristics and a hard-wiring connection between each one of the fixtures and the elevator control.

28. A method for determining a position information for each of a plurality of fixtures of an elevator arrangement, the fixtures being located at various floors within a building and each of the fixtures including a sound detector for detecting sound characteristics of sound propagating within an elevator shaft of the building, the method comprising the steps of:
determining a position information for each of the fixtures based on the sound characteristics of the sound propagating within the elevator shaft and detected by the sound detector included in the fixture; and
storing the determined position information for subsequent identification purposes for each of the fixtures.

29. A computer program product comprising computer readable instructions which, when executed by a programmable elevator control, perform the method according to claim 28.

30. A non-transitory computer readable medium comprising a computer program product according to claim 29 stored thereon.
